(19) United States
(12) Patent Application Publication
(10) Pub. No.: US 2002/0039398 A1
(43) Pub. Date: Apr. 4, 2002

(54) Apparatus and method for dynamic bit allocation for line-connected multi-carrier systems

(76) Inventor: Robert Klinski, Muenchen (DE)

Correspondence Address: Kevin R. Spivak, Morrison & Foerster LLP, Suite 5500, 2000 Pennsylvania Avenue, N.W., Washington, DC, 20006-1888, US

(21) Appl. No.: 09/861,549

(22) Filed: May 22, 2001

(30) Foreign Application Priority Data
May 22, 2000 (DE) DE10025018.1
Aug. 22, 2000 (DE) DE10041068.5

(51) Int. Cl. H04K 1/10; H04L 27/28; H04L 23/00

(52) U.S. Cl. 375/377; 375/260

(57) ABSTRACT

An apparatus and method for dynamic bit allocation for line-connected multicarrier systems, which allows high-quality data transmission, even when the interference signals are varying with time, in a simple and cost-effective manner.

### TECHNICAL FIELD OF THE INVENTION

The invention relates to an apparatus and a method for dynamic bit allocation for line-connected multicarrier systems and, in particular, to an apparatus and a method for rapid matching of xDSL transmission systems to changed signal-to-noise ratios.

### BACKGROUND OF THE INVENTION

Conventional digital multicarrier systems transmit and receive digital signals using a large number of carriers or subchannels at different trequencies. A transmitter in this case splits a transmission signal into a large number of components, allocates the compents to a specific carrier, codes each carrier in accordance with its component, and transmits each carrier via one or more transmssion

The maximum amount of information which can be coded on a specific carrier is in this case a function of the signal-to-noise ratio (SNR) with respect to the carrier. The signal-to-noise ratio of a transmission channel may, however, be frequency-dependent, so that the maximum amount of information which can be coded on a carrier differs from one carrier to another.

Use of the bit loading method allows specific allocation of respective bits to carriers or subchannels as a function of a signal-to-noise ratio that exists on the carrier. A bit loading algorithm provides values for a bit allocation table (BAT), which indicates an information set to be coded for a respective carrier, and allocates this information set to that Carrier.

FIG. 1 shows a simplified block diagram of a line-connected multicarrier system according to the prior art. The multicarrier system comprises, for example, a transmitter 1, a transmission medium or channel 3, and a receiver 3. If a bandpass system is used, an RF modulation system 4 with an RF modulator 5 and an PF (demodulator 6 may, optionally, also be used.

As shown in FIG. 1, serial input data to be transmitted are initially converted, for example in a serial/parallel converter 10, into a parallel data stream. The parallel data stream is then coded by a coding stage 11, as a function of a bit allocation table 15 the transmission end. Specifically, each carrier is assigned a signal space constellation which is dependent on an existing signal-to-noise ratio and is established or optimized by a bit loading algorithm, during an initialization or training phase, as a bit allocation table in conventional multicarrier systems. The signal coded (in the frequency domain) in such a manner is then formed in a pulse former 12 into suitable transmission pulses and is converted by a time-domain medulator 13 to a time domain, as a result of which can a multicarrier signal is produced. The multicarrier signal is then combined by an adder 14.

The subchannels or carriers for the received signal and for the input data values y′ are first separated in the receiver 3, which, as shown in FIG. 1, is constructed symmetrically with respect to the transmitter 1, are changed to the frequency domain once again by a frequency domain modulator 16, are low-pass filtered (LP-filter) in a reception filter 17 and, after a large number of further processing stages which are not illustrated, are supplied to a decision maker 18. During the training phase, the decision maker input data values Y which are present upstream of the decision maker 18 are derived and are compared, by a noise variance determination apparatus 7, with reference signals or reference data values Ref X which are known at the receiving end, by which a noise variance or noise power is determined for the respective decision maker input data values Y. A bit allocation table 9 at the receiver end is described and adapted on the basis of this noise variance via a bit loading apparatus and a bit loading algorithm which is executed in it. The transmission end bit allocation table it is in this case matched to the receiver-end bit allocation table 9 via, or example a return or control channel. The decision maker 18 is in this case used for allocation of the (inaccurate) decision maker input data value (Y) to an (exact) value of a predetermined value set of a transmission format (such as 4QAM) which is being used. A subsequent decoder stage 19 then decodes the received data as a function out the values in the bit allocation table 9, with a parallel/serial converter 20 converting the parallel data stream to a serial data stream, once again.

In this way, a bit allocation table is obtained which Is optimized for a signal-to-noise ratio during the initialization phase or training phase, by which minimum bit error rates can be achieved for the output data (values). However, a disadvantage of such a conventional multicarrier system is the fact that interference signals introduced to the transmission medium after an initialization phase can lead to considerable deterioration, or even to breakdown, of the data transmission.

As an alternative, the signal-to-noise ratio (SNR) could thus be determined on the basis of the (output) values decided on by the decision maker 18. However, this option is too slow for interference which varies severely with time—the bit allocation table cannot be recalculated quickly enough in response to a significant change in the signal-to-noise ratio. This can lead to a breakdown in data transmission. However, such a drop-out time is unacceptable for users, particularly when transmitting voice data.

### SUMMARY OF THE INVENTION

In one embodiment of the invention, an apparatus for dynamic bit allocation for line-connected multicarrier systems, including a decision maker for allocating a decision maker input data value to a value in a predetermined value set of a transformation format; a bit allocation table for defining an information set, to be decoded/coded, on a carrier of the multicarrier system; a bit loading apparatus for changing the bit allocation table; and a noise variance determination apparatus for actuating the bit loading apparatus as a function of a noise variance calculation from the processed input data value and from known reference data value, wherein at least one noise variance estimation apparatus for actuating the bit loading apparatus as a function of a noise variance which is estimated from an input data value, with the input data value being derived from a data input path at a time before the decision maker input value.

In one aspect of the invention, the noise variance estimation apparatus has a magnitude estimator for estimating a magnitude of the input data value.

In another aspect of the invention, the noise variance estimation apparatus has an SNR estimator for estimating a signal-to-noise ratio of the input data value or the estimated magnitude of the input data value.

In yet another aspect of the invention, the data input path has at least one frequency band modulator and one reception filter, with the input data value being derived upstream of the reception filter, and the decision maker input value being derived downstream from the reception filter.

In still another aspect of the invention, further including an RF modulation system (4) for providing a bandpass system.

In yet another aspect of the invention, the noise variance determination apparatus and the noise variance estimation apparatus are constructed identically.

In still another aspect of the invention, the apparatus is provided at the exchange end and/or at the subscriber end.

In yet another aspect of the invention, the multicarrier system represents an ADSL or UDSL system.

In another embodiment of the invention, there is a method for dynamic bit allocation for line-connected multicarrier systems, including deriving an input data value in a data input path at a time before a decision maker input data value; estimating a noise variance on the basis of the input data value; and executing a bit loading algorithm in order to change a bit allocation table on the basis of the estimated noise variance.

In one aspect of the invention, the magnitude of the input data value is estimated or detected during the estimating.

In yet another aspect of the invention, the signal-to-noise ratio of the input value data is estimated during the estimating.

In still another aspect of the invention, the method can be carried out at the exchange end and/or at the subscriber end.

In yet another aspect of the invention, the method is carried out during a training phase and/or while data are being transmitted.

In still another aspect of the invention, the method is carried out using an ADLS or UDSL system.

### BRIEF DESCRIPTION OF THE DRAWINGS

The invention will be described in more detail in the following text using an exemplary embodiment and with reference to the drawings.

FIG. 1 shows a simplified block diagram of a line-connected multicarrier system according to the prior art.

FIG. 2 shows a simplified block diagram of a line-connected multicarrier system with dynamic bit allocation according to the present invention.

FIG. 3 shows a simplified block diagram of a decision maker.

FIGS. 4A and 4B show a graphical representation of the process of determining the signal-to-noise ratio according to the invention, and of an associated bit distribution process.

### DETAILED DESCRIPTION OF THE INVENTION

The invention includes an apparatus and a method for dynamic bit allocation for line-connected multicarrier systems, which allows high-quality data transmission, even when the interference signals are varying with time, in a simple and cost-effective manner.

The use of at least one noise variance estimation apparatus, in particular, for actuating a bit loading apparatus as a function of a noise variance estimated from an input data value, with the input data value being derived from a data input path at a time before a decision maker input value, results in considerably faster adaptation of a bit allocation table than when using the output values from the decision maker as reference data values, for which reason dynamic bit allocation can also be provided without any significant adverse affect on the data transmission characteristics.

For example, the noise variance estimation apparatus has a magnitude estimator for estimating a magnitude of the input data value. This relatively coarse estimation results in a further reduction in the time for changing a bit allocation table, as a result of which it is possible to follow changing signal-to-noise ratios on the transmission medium or channel even while data are being transmitted. Furthermore, for dynamic bit allocation, the noise variance estimation apparatus may alternatively or in addition have an SNR estimator for estimating a signal-to-noise ratio of the input data value or the estimated magnitude of the input data value. The time required for calculating and changing the new bit allocation table is further reduced in this way, thus ensuring optimum adaptation in dynamic processes.

The noise variance determination apparatus and the noise variance estimation apparatus may preferably be of identical construction, thus making it possible to achieve better estimation accuracy.

In the following example, the channel impulse response for a line-connected multicarrier system or for line-connected transmission does not vary with time. This means that interference power densities which vary severely with time have a considerable influence on the transmission performance and, in conventional systems, these are detected only during a training or initialization phase. If such interference power densities vary while data are being transmitted, then a system is required which allows these dynamic changes to be identified quickly.

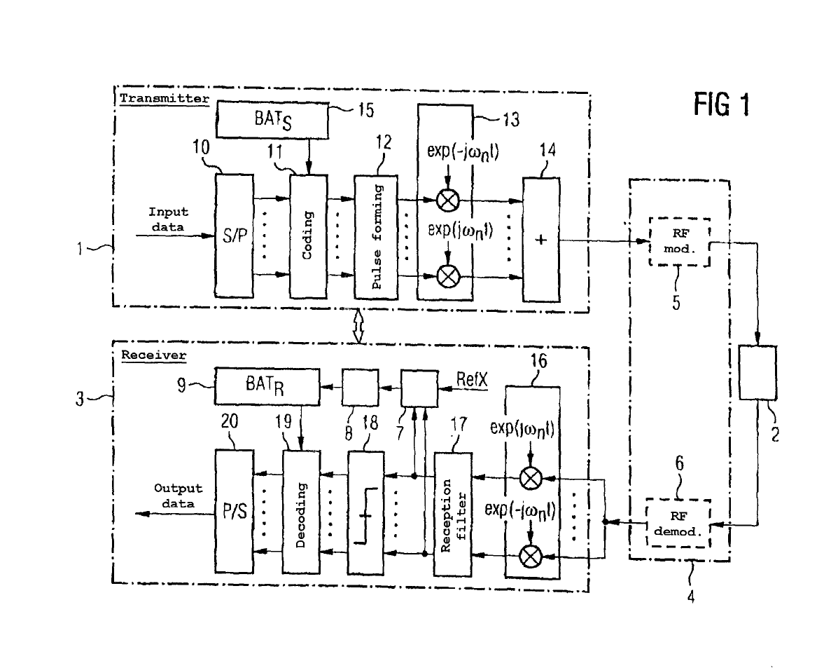

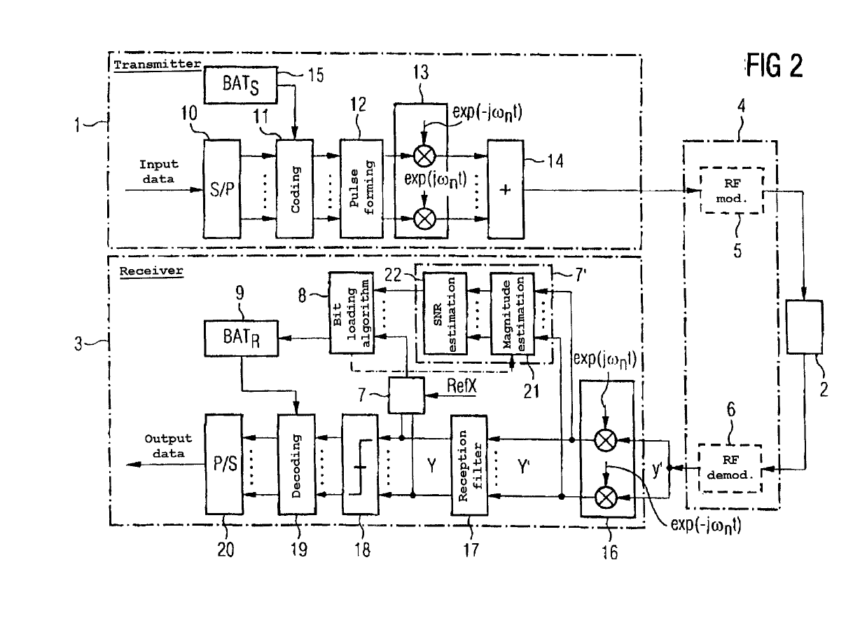

FIG. 2 shows a simplified block diagram of a line-connected multicarrier system according to the present invention, with identical reference symbols representing the same elements as in FIG. 1, and with these elements not being described yet again in the following text.

According to FIG. 2, the line-connected multicarrier system according to the invention comprises a transmitter 1, a transmission medium or channel 2 and a receiver 3, in which case a bandpass system can optionally be provided by an RF modulation system 4 with an RF modulator 5 and an RF demodulator 6. The line-connected multicarrier system according to the invention, and as shown in FIG. 2 represents a further development of the multicarrier system which is illustrated in FIG. 17 with additional dynamic bit allocation. However, the present invention is not limited exclusively to the multicarrier systems illustrated in FIGS. 1 and 2, but can also be applied to any other desired line-connected multicarrier systems, such as those which are generally known as ADSL (asymmetric digital subscriber line), VHDSL and UDSL systems. Furthermore, the present invention can be used both at the exchange end, that is to say downstream, and at the subscriber end, that is to say upstream.

The present description recites data transmission in one direction, for reasons of clarity, although data transmission may be in more than one direction.

According to FIG. 2, serial input data to be transmitted are converted in a serial/parallel converter 10 to a parallel data stream, and are then coded by a coder stage 11 as a function of a bit allocation table 15 (BATₛ) at the transmission end. The signal coded in this way is then changed in a pulse former 12 into suitable transmission pulses, and is changed by a time-domain modulator 13 from a frequency domain to a time domain, by which a multicarrier signal is produced. By way of example, the time domain modulator 13 carries out an inverse discrete Fourier transformation. Initially, the multicarrier signal is complex, with a real signal being produced for transmission, which is combined by an adder 14.

The transmission on the transmission medium 2 takes place essentially in one or more transmission channels, with conventional two-wire lines preferably being used as the transmission medium.

At the receiver end, the received data signal, which has been subjected to interference signals, and the data input values y′ are now split, are changed to the frequency domain once again by a frequency domain modulator 16, and are supplied to a reception filter 17 and, after a large number of further processing stages (which are not illustrated) are supplied as the decision maker input data value Y to a decision maker 18. These data signals, which have been initially filtered by the reception filter 17 and are hence relatively accurate (but time-delayed) are supplied in an initialization or training phase to a noise variance determination apparatus 7, which determines a signal-to-noise ratio, which exists during the training phase, and/or a noise variance of the decision maker input data value Y for a respective carrier, as a function of a known reference data sequence Ref X. On the basis of these determined signal-to-noise ratios, a receiver-end bit allocation table 9 (BATᵣ) is then set via a bit loading apparatus 8 in such a manner that this results in minimum bit error rates on the respective carriers. To this end, a downstream decoder stage 19 decodes the received data as a function of the values in the bit allocation table 9, with a parallel/serial converter 20 once again converting the parallel data stream to a serial data stream or to the serial output data. As in the case of the prior art shown in FIG. 1, the transmitter-end and receiver-end bit allocation tables 9 and 15 are also adapted and matched via a separate return channel in the multicarrier system shown in FIG. 2. In this way, a new bit allocation for the respective coder stage 11 and decoder stage 19 is reported both to the receiver and to the transmitter.

In order to provide dynamic bit allocation, for example, after a training or initialization phase, input data values Y′ are derived and are supplied to a noise variance estimation apparatus 7′ in the data input path at an early point in time, for example following the frequency domain modulator 16. To be more precise, the noise variance estimation apparatus 7′ allows a noise variance and/or a noise power level for the input data values Y′ derived at an early point in time to be estimated roughly while data are being transmitted, and for a change to be made to the bit allocation table 9 as a function of this noise variance, via the bit loading apparatus 8 and the bit loading algorithm provided in it. Since the input data values Y′ are derived well before the decision maker 18 in a data input path, and are preferably tapped off directly from the line connection, the bit allocation table setting carried out by the noise variance estimation apparatus 7′ is subject to a considerably shorter data signal time delay than the setting carried out by the noise variance determination apparatus 7.

In the simplest case, the noise variance estimation apparatus 7′ may be constructed identically to the noise variance determination apparatus 7.

In order to reduce the drop-out times further and/or to reduce the bit error rates, a considerably coarser calculation or determination of the bit allocation can also be carried out when the noise variance estimation apparatus 7′ is provided. To be more precise, for example, a magnitude of a transmitted data signal or of the input data value Y′ is no longer detected exactly, but is merely estimated, thus resulting in further time being saved. Such magnitude estimation is carried out, for example, by a magnitude estimator 21.

Furthermore, in addition to exact determination of the signal-to-noise ratio (SNR), a coarse estimate of the signal-to-noise ratio can once again be made by an SNR estimator 22, thus further reducing the time required and the computation complexity.

It should be expressly mentioned at this point that the noise variance estimation apparatus 7′ can also be provided in other ways. In the noise variance estimation apparatus illustrated in FIG. 2, the SNR estimator may, for example, also be omitted, with the bit loading apparatus being actuated directly from the magnitude estimator.

On the basis of a noise variance (magnitude, signal-to-noise ratio, . . . ) estimated in in the manner described, the bit loading apparatus 8 can be used for very rapid, dynamic updating of the bit allocation table 9, which process produces virtually zero noticeable bit error rates or drop-out times while data are being transmitted. In FIG. 2, the same bit loading apparatus is used for dynamic and steady-state bit allocation, although two separate bit loading apparatuses can also be used.

The following text includes a mathematical description of the functions of the present invention.

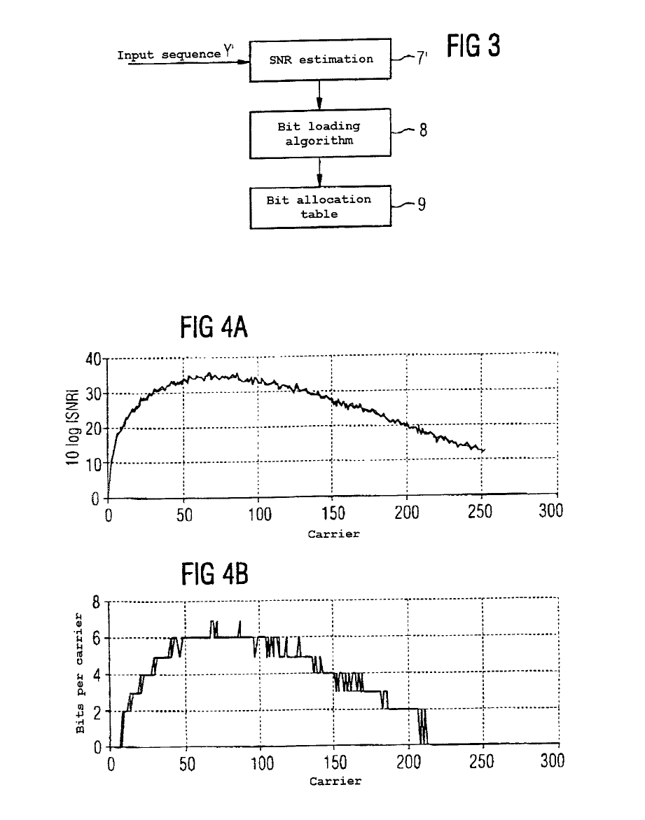

FIG. 3 shows a simplified block diagram of a noise variance estimation apparatus.

During the training phase or initialization phase, known reference data sequences Ref X are used to determine the signal-to-noise ratio, and are used with a data sequence or the decision maker input data values Y being received at that time to calculate the signal-to-noise ratio. According to the prior art, the signal-to-noise ratio SNR is obtained as follows:

$$SNR ( k ) = \frac{E {\vert {X}_{k} \vert}^{2}}{E {\vert {X}_{k} - {Y}_{k} \vert}^{2}} = \frac{{‖ {X}_{k} ‖}^{2}}{{‖ {X}_{k} - {Y}_{k} ‖}^{2}} \qquad Equation 1$$

with the operator E( . . . ) denoting an expected value and ¦¦. . . ¦¦ denoting a magnitude of a complex number.

A bit loading algorithm in this case uses the SNR as the basis for calculating a bit allocation per carrier using, for example, a standard algorithm:

$$\frac{\# bits}{sub - symbol \# k} = Round [ {log}_{2} ( \frac{3 SNR}{{{Q}^{- 1} ( BER )}^{2}} ) + 1 ] \qquad Equation 2$$

where BER denotes a desired bit error probability (for example BER=10⁻⁷ for ADSL) and Q( . . . ) denotes the error function.

Since no reference data sequences X are available while data are being transmitted (that is to say for dynamic bit allocation), the signal-to-noise ratio SNR cannot be updated, and any bit assignment cannot be changed. In an extreme case, this can lead to the data link collapsing.

In the following example, the amount of transmitted data in specific transmission formats is assumed to be known. This assumption is satisfied for MPSK multicarrier transmission. If, on the other hand, QAM (quadrature amplitude modulation) is used as the transmission format, then a so-called bit load vector provides information on the signal space constellation which is assigned to a respective carrier. In general, this allows the amount of transmitted data to be determined, or at least estimated, provided the signal-to-noise ratio is not excessively low. For line-connected transmission systems, this assumption is likewise invariably satisfied.

In a multicarrier system V1, . . . VM denote all the possible transmitted NQAM amounts per carrier k and ¦Y(k) ¦ denotes the magnitude of the received signal (carrier K). In this situation, the so-called maximum-likelihood approach may be used, for example, to determine the amount of transmitted data ¦X(k)¦ as follows:

¦X(k)¦=min¦ ¦Y(k)−[V₁ . . . Vₘ]¦

The following text describes a mathematical approximation for the signal-to-noise ratio SNR, with this approximation being used for dynamic definition of the bit occupancy, and incurring a particularly small time penalty and computation effect. The following inequality can be defined on the basis of equation 2:

$$\frac{E {\vert {X}_{k} \vert}^{2}}{E {\vert {X}_{k} - {Y}_{k} \vert}^{2}} \leq \frac{E {\vert {X}_{k} \vert}^{2}}{E {‖ {X}_{k} \vert - \vert {Y}_{k} ‖}^{2}} \qquad Equation 3$$

More detailed mathematical analysis of equation 3 results in the following further simplification or estimate.

$$SNR ( k ) \approx 0.5 \cdot \frac{E {\vert {X}_{k} \vert}^{2}}{E {‖ {X}_{k} \vert - \vert {Y}_{k} ‖}^{2}} \qquad Equation 4$$

where E¦X₂¦² denotes the signal power and 0.5 E¦¦X_{k¦-E¦Y}ₖ¦¦² denotes the noise variance.

The estimate shown in equation 4 represents one possible way to determine the signal-to-noise ratio, although a large number of other estimation procedures are feasible. This estimation process, which can be carried out very easily, provides an adequate basis for dynamic bit allocation, however, provided it is applied to the incoming data signals sufficiently early (in the data input path).

To be more precise, the estimation process carried out in equation 4 is carried out in the noise variance estimation apparatus 7′, and the bit allocation table 9 is updated on the basis of this estimate, using a bit loading algorithm executed in the bit loading apparatus 8.

The use of a signal or input data value Y′, which is admittedly very dirty, at an early stage allows the drop-out times that occur during a change to the bit allocation table 9 to be considerably shortened, as a result of which such dynamic bit allocation is suitable even for voice transmission. Previously normal drop-out times of approximately 10 to 15 seconds are reduced to values in the region of one second.

The reduced accuracy that results from this for dynamic bit allocation leads, according to FIGS. 4a and 4b, to an insignificant deterioration in the transmission characteristics. FIGS. 4A and 4B show a graphical representation of the process according to the invention for determining the signal-to-noise ratio, and associated bit distribution in comparison to an exact calculation, and this shows minor discrepancies.

According to FIG. 2, the magnitude estimator 21 is located in the noise variance estimation apparatus 7′. The magnitude estimator 21 may, however, be incorporated in any other point, and, in particular, may be integrated in the decision maker 18. If the magnitude estimator is used at some other point in the multicarrier system, this can result in further simplification of the design of the transmitter or receiver.

The invention has been described above on the basis of one specific multicarrier system using MTSK or QAM transmission. However, it is not limited to this and, in fact, covers all other line-connected multicarrier systems in which dynamic bit allocation is carried out by means of an additional noise variance estimation apparatus. Furthermore, a number of noise variance estimation apparatuses may also be arranged in the form of a cascade, and, in time, before the decision maker.

What is claimed is:

1. An apparatus for dynamic bit allocation for line-connected multicarrier systems, comprising:
a decision maker for allocating a decision maker input data value to a value in a predetermined value set of a transformation format;
a bit allocation table for defining an information set, to be decoded/coded, on a carrier of the multicarrier system;
a bit loading apparatus for changing the bit allocation table; and
a noise variance determination apparatus for actuating the bit loading apparatus as a function of a noise variance calculation from the processed input data value and from a known reference data value, wherein
at least one noise variance estimation apparatus for actuating the bit loading apparatus as a function of a noise variance which is estimated from an input data value, with the input data value being derived from a data input path at a time before the decision maker input value.

2. The apparatus as claimed in claim 1, wherein the noise variance estimation apparatus has a magnitude estimator for estimating a magnitude of the input data value.

3. The apparatus as claimed in claim 1, wherein the noise variance estimation apparatus has an SNR estimator for estimating a signal-to-noise ratio of the input data value or the estimated magnitude of the input data value.

4. The apparatus as claimed in claim 1, wherein the data input path has at least one frequency band modulator and one reception filter, with the input data value being derived upstream of the reception filter, and the decision maker input value being derived downstream from the reception filter.

5. The apparatus as claimed in claim 1, further comprising an RF modulation system (4) for providing a bandpass system.

6. The apparatus as claimed in claim 1, wherein the noise variance determination apparatus and the noise variance estimation apparatus are constructed identically.

7. The apparatus as claimed in claim 1, wherein said apparatus is provided at the exchange end and/or at the subscriber end.

8. The apparatus as claimed in claim 1, wherein the multicarrier system represents an ADSL or UDSL system.

9. A method for dynamic bit allocation for line-connected multicarrier systems, comprising:
deriving an input data value in a data input path at a time before a decision maker input data value;
estimating a noise variance on the basis of the input data value; and
executing a bit loading algorithm in order to change a bit allocation table on the basis of the estimated noise variance.

10. The method as claimed in claim 9, wherein the magnitude of the input data value is estimated or detected during the estimating.

11. The method as claimed in claim 9, wherein the signal-to-noise ratio of the input value data is estimated during the estimating.

12. The method as claimed in claim 9, wherein said method can be carried out at the exchange end and/or at the subscriber end.

13. The method as claimed in claim 9, wherein said method is carried out during a training phase and/or while data are being transmitted.

14. The method as claimed in claim 9, wherein said method is carried out using an ADLS or UDSL system.
